(19) United States
(12) Patent Application Publication
(10) Pub. No.: US 2012/0196668 A1
(43) Pub. Date: Aug. 2, 2012

(54) GAMING SYSTEM AND METHOD OF GAMING

(76) Inventor: Stephen MacNish, Bunbury (AU)

(21) Appl. No.: 13/499,832

(22) PCT Filed: Sep. 29, 2010
(86) PCT No.: PCT/AU2010/001279

§ 371 Date: Apr. 2, 2012

(30) Foreign Application Priority Data
Oct. 2, 2009 (AU) 2009904855

(51) Int. Cl. A63F 13/00; A63F 9/24

(52) U.S. Cl. 463/17

(57) ABSTRACT

A gaming system is disclosed which includes a selector arranged to facilitate selection of a player set of characters from a set of game characters. The gaming system is arranged to associate participants in at least one event with respective game characters of the set of game characters. The gaming system also includes a winning character determiner arranged to determine a set of winning characters from the game characters associated with the participants based on performance of the participants in the at least one event, and an outcome determiner arranged to determine whether a win condition exists by comparing the player characters with the winning characters. A corresponding method is also disclosed.

### FIELD OF THE INVENTION

The present invention relates to a gaming system and to a method of gaming.

### BACKGROUND OF THE INVENTION

It is known to provide a gaming system arranged to operate as a lottery wherein a player purchases a ticket in the lottery in order to obtain an opportunity to win a prize. Generally, each ticket is associated with a set of player numbers selected from a pool of game numbers, and a set of winning numbers is randomly selected from the pool of game numbers and compared with the selected player numbers in order to determine whether the ticket corresponds to a win. Such lottery type games have wide appeal because they are easy to understand and play and because the maximum prize tends to grow very large, since the odds of winning are relatively low.

However, apart from during the short time taken to observe and check the winning numbers with the selected player numbers on a players ticket, player excitement for this type of game is limited.

In an alternative gaming system a player is provided with the opportunity to select a plurality of participants in one or more events from a pool of participants in the events, and a performance score is allocated to each of the participants according to an objective assessment of the performance of the participant in an event. For example, the events may comprise a series of soccer matches and each participant may be a player in one of the soccer matches. Points may be allocated to a participant for actions carried out during a game of soccer such as scoring a goal, assisting a goal, and so on. Generally, a player having the highest total score, or all players having total scores above a defined threshold are allocated a prize.

However, this type of gaming system requires decisions to be made by players and a significant amount of time and input is required in order to determine which participants to select. Accordingly, this type of gaming system is not widely played.

### SUMMARY OF THE INVENTION

In accordance with a first aspect of the present invention, there is provided a gaming system comprising:
a selector arranged to facilitate selection of a player set of characters from a set of game characters;
the gaming system being arranged to associate participants in at least one event with respective game characters of the set of game characters;
the gaming system further comprising:
a winning character determiner arranged to determine a set of winning characters from the game characters associated with the participants based on performance of the participants in the at least one event; and
an outcome determiner arranged to determine whether a win condition exists by comparing the player characters with the winning characters.

In one embodiment, the selector is arranged to facilitate selection of player characters from the set of game characters by a player.

In an alternative embodiment, the selector is arranged to facilitate selection of the player characters automatically.

In one embodiment, the selector is arranged to randomly select the player characters from the set of game characters.

In one embodiment, for each game the game characters are associated with the same participants for all players.

In an alternative embodiment, for each game the game characters are associated with different participants for at least some players.

In one arrangement, for each game the player characters are the same for all players, and the gaming system is arranged such that for each player the participants are randomly associated with respective game characters of the set of game characters.

In one embodiment, the number of game characters is the same as the number of participants and each participant is associated with a different game character.

In an alternative embodiment, the number of participants is greater than the number of game characters and at least some of the participants are associated with the same game character.

In an alternative embodiment, the gaming system is arranged to select a sub-set of a set of participants in at least one event, and to associate each participant of the selected sub-set of participants with a game character.

In one embodiment, the sub-set of participants is randomly selected from the set of participants.

In one embodiment, the game characters are randomly associated with respective participants.

In one arrangement, the winning character determiner is arranged to determine the set of winning characters by determining a defined number of game characters corresponding to the best performances of the participants associated with the game characters in the at least one event.

The system may be arranged to receive a points score indicative of the performance of each participant and the winning character determiner may be arranged to determine the best performing participants by ranking the points scores.

In one arrangement, the gaming system is arranged to combine the points scored by a plurality of participants, and the outcome evaluator is arranged to determine a winning outcome dependent on the combined points score.

In one embodiment, the participants used to produce the combined points score are all participants associated with the game characters, or a sub set of participants associated with the player characters.

In the event that 2 or more players achieve the same winning outcome, the gaming system may be arranged to apply a distinguishing criterion based on the combined points score in order to determine which of the players will win a particular prize.

In one embodiment, the gaming system is arranged to receive information indicative of performance of the participants on-line from a remote location.

In one arrangement, the winning character determiner is arranged to determine the set of winning characters as 8 game characters corresponding to the 8 best performing participants.

In one arrangement, the selector is arranged to facilitate selection of 6 game characters from the set of game characters as the player characters.

In one embodiment, the outcome evaluator is arranged to define a first win condition if the player characters match with a first set of winning characters, and to define a second win condition if the player characters match with a second set of winning characters, the second set of winning characters having more winning characters than the first set of winning characters and the first and second win conditions corresponding to different prizes.

The at least one event may comprise at least one sporting event.

In one embodiment, the gaming system is arranged to select a sub-set of a set of participants in at least one event for association with a set of game characters, the sub-set of participants comprising a plurality of players in a team sport event.

In one embodiment, the sub-set of players comprise the equivalent of one or more sporting teams with each playing position in a respective team being represented by a participant.

The at least one event may comprise at least one of an Australian rules football game, a soccer match, a cricket match, a baseball game, a basketball game, a racing event such as a horse or greyhound racing event or a motor racing event.

In one embodiment, the game characters, the player characters and the winning characters are numbers.

In an alternative embodiment, the game characters, the player characters and the winning characters are participant names or graphical indicia representative of participants.

In one embodiment, the gaming system is arranged so as to normalise the likelihood of a particular set of participant names constituting a winning outcome so that no particular combination of participant names selected by a player as the player characters is significantly more likely to constitute a winning outcome than other combinations.

The gaming system may be arranged to allocate a handicap value to each participant and to use the handicap value to modify the participant performance score according to the ability of the participant.

Alternatively, the gaming system may be arranged to allocate a point value to each participant indicative of the ability of the participant, and to allow a player to select the participants to form the player characters up to a combined maximum total points value, and wherein the winning character determiner is arranged to determine winning characters by using the highest performance points ranking participant combination which is within the maximum total points value.

In one embodiment, the gaming system is arranged to continually update the set of winning characters during the at least one event such that a current set of winning characters is based on current performance of the participants in the at least one event.

In one arrangement, information indicative of a relevant set of current winning characters for a game is made available to a player associated with the game.

The information indicative of a relevant set of current winning characters for a game may be made available on-line.

In one embodiment, each game has an associated identifier which is communicated to a player and which is usable by the player to access information indicative of a relevant set of current winning characters for each game.

The gaming system may be arranged to make information indicative of the set of current winning characters for each game available to a player by displaying the set of player characters and representing the player characters differently depending on whether a character in the set of player characters matches with a character in the set of current winning characters.

The player characters may be displayed differently depending on whether the player characters correspond to a participant not yet involved in an event, currently involved in an event and/or has been involved in an event which has finished and can no longer constitute a match with a winning character.

In accordance with a second aspect of the present invention, there is provided a method of gaming comprising:
associating participants in at least one event with respective game characters of a set of game characters;
selecting a player set of characters from the set of game characters;
determining a set of winning characters from the game characters associated with the participants based on performance of the participants in the at least one event; and
determining whether a win condition exists by comparing the player characters with the winning characters.

In accordance with a third aspect of the present invention, there is provided a method of determining winning characters in a game wherein an outcome of the game is dependent on selection of the winning characters, the method comprising:
associating participants in at least one event with respective characters of a set of game characters; and
determining a winning set of characters from said game characters based on performance of said participants in the at least one event.

### BRIEF DESCRIPTION OF THE DRAWINGS

The present invention will now be described, by way of example only, with reference to the accompanying drawings, in which:

FIG. 1 is a schematic block diagram of a gaming system in accordance with an embodiment of the present invention;

FIG. 2 is a schematic block diagram illustrating a game controller of the system shown in FIG. 1 in more detail;

FIG. 3 is a diagrammatic representation of a participant table of the system shown in FIG. 1;

FIG. 4 is a diagrammatic representation of a selected participants table of the system shown in FIG. 1;

FIG. 5 is a diagrammatic representation of a ticket issued to a player of the system shown in FIG. 1 during use;

FIG. 6 is a schematic diagram illustrating functional components of a game controller of the system shown in FIG. 1;

FIG. 7 is a flow diagram game play of a gaming system in accordance with an embodiment of the present invention;

FIG. 8 is a diagrammatic representation of a game status screen produced by a gaming system in accordance with an embodiment of the present invention;

FIG. 9 is a diagrammatic representation of a game status screen produced by an alternative embodiment of a gaming system in accordance with the present invention;

FIGS. 10 to 15 are diagrammatic representations of screens produced on a portable communications enabled device according to a further alternative embodiment of a gaming system in accordance with the present invention; and

FIG. 16 is a diagrammatic representation of a player character selection screen presented to a player during implementation of a gaming system in accordance with an embodiment of the present invention.

### DESCRIPTION OF AN EMBODIMENT OF THE INVENTION

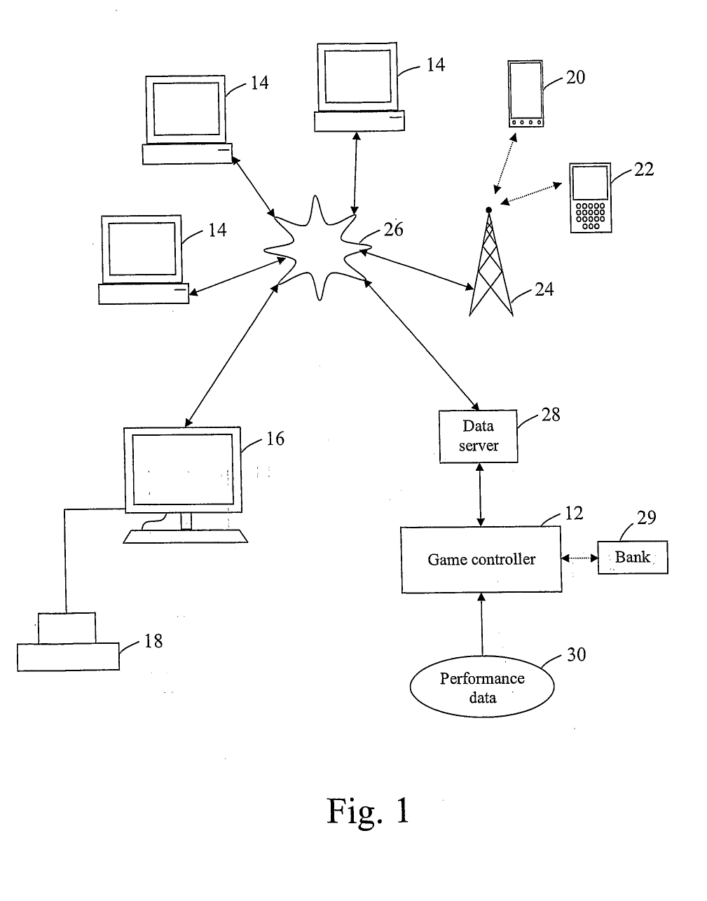

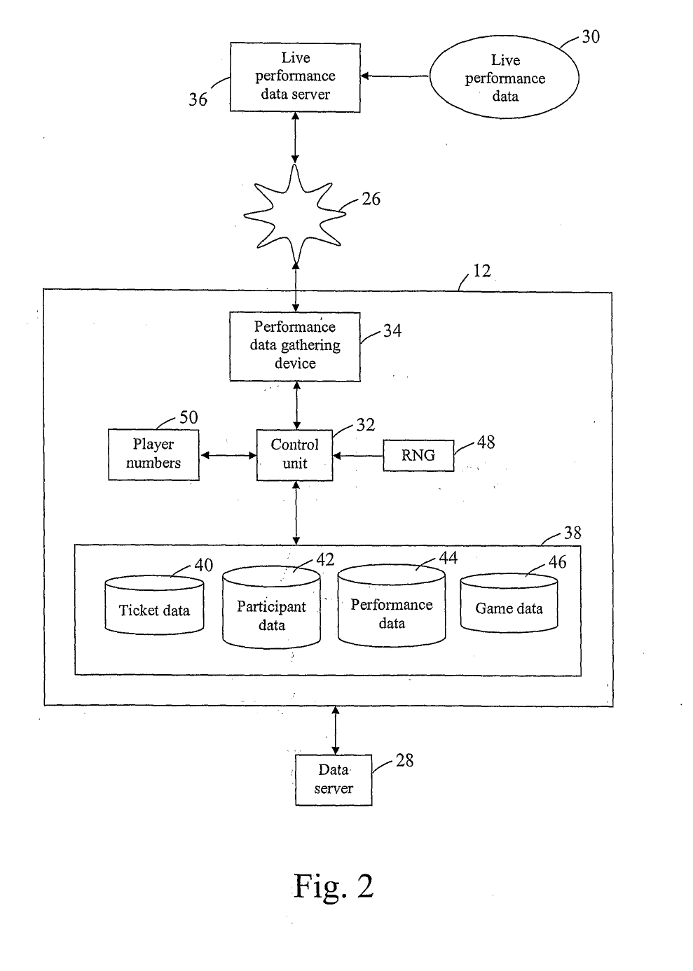

Referring to the drawings, there is shown in FIGS. 1 and 2 a schematic block diagram of a gaming system 10 arranged to implement a game of the type wherein multiple players obtain tickets, for example by purchasing the tickets, in order to gain an opportunity to win a prize, generally in the form of a monetary amount.

The present gaming system 10 operates such that when a player obtains a ticket, for each game on the ticket a set of player characters are selected by a player or randomly from a set of game characters, a set of participants in one or more events are associated with each game on the ticket, and each character from the set of game characters is linked to at least one of the associated participants.

In one example, the characters are numbers, and purchasing a ticket provides a player with a set of player numbers for each game purchased. As the event(s) occur the participants are allocated points for certain actions such that the points score for each participant is indicative of a performance of the participant in the event. At the end of the event(s) a defined number of the highest scoring participants are used to determine a set of winning numbers, and the selected set(s) of player numbers on the ticket are compared with the winning numbers to determine whether the ticket corresponds to a win. In some embodiments, the events comprise one or more sporting events such as soccer matches, Australian rules football games, cricket matches, racing events such as horse or greyhound racing events or motor racing events, and so on, with participants being allocated points for carrying out actions beneficial to the team during the event, such as scoring a goal in soccer, assisting a goal in soccer, marking the ball in Australian rules football, scoring 6 runs in cricket, and so on.

The performance points allocated to a participant for carrying out an action beneficial to the team may be different depending on the action. For example, more points may be allocated to a participant for scoring a goal than assisting a goal, and so on.

The set of participants allocated to each game may be the same or may be different. In addition, for each game, the participants may be associated with the same game characters or different characters.

Referring to FIG. 1, the gaming system 10 comprises a game controller 12 arranged to control and coordinate implementation of a game, and a plurality of game play devices usable to purchase tickets and, in this embodiment, at least some of which are useable to monitor progress of a game.

In this example, the game play devices comprise computing devices in the form of personal computers 14, a dedicated game play terminal 16 and associated printer 18, and mobile communications devices such as a touch phone/PDA 20 and a keyboard-type mobile phone 22. Such a dedicated game play terminal 16 would ordinarily be located at a retail outlet and may correspond to an existing game play terminal used to dispense conventional lottery tickets and suitably modified to also dispense tickets according to the present gaming system.

Each of the game play devices 14, 16, 20, 22 in this example is arranged to communicate with the game controller 12 from a remote location, with the touch phone/PDA 20 and the mobile phone 22 communicating with the game controller 12 through a telephone communications network 24 and the Internet 26, and the personal computing devices 14 and the dedicated game play terminal 16 communicating with the game controller through the Internet 12.

In this example, the game play devices 14, 16, 20, 22 communicate with the game controller 12 using a data server 28 which may comprise a web server (not shown) to facilitate serving of data indicative of web pages to the game play devices and receipt of data from the game play devices for use by the game controller 12. It will be understood, however, that any suitable mechanism for facilitating communications between the game controller 12 and the game play devices is envisaged. The system 10 may be arranged such that communications between the game play devices and the game controller are secure, for example by encrypting the communications.

The system 10 is arranged so as to enable tickets to be purchased using one or more of the game play devices and, for this purpose, the game controller 12 in this example is arranged to communicate with a bank 29 for the purpose of validating account, credit card, or other personal financial data should a player choose to pay for a ticket electronically.

As discussed above, the system 10 uses performance statistics of participants in one or more events to determine a set of winning characters (in this example numbers) and, for this purpose, the game controller 12 in this example is arranged to receive performance data 30 from a suitable source of such data.

The game controller 12 is shown in more detail in FIG. 2.

In this example, the game controller 12 includes a control unit 32 for controlling and coordinating operations in the game controller 12, a performance data gathering device 34 arranged to receive data, in this example through the Internet 26, from a live performance data server 36 arranged to receive and send live performance data relevant to participants in one or more events to the performance data gathering device 34, and a data storage device 38 arranged to store data and programs used by the control unit 32 in order to implement a game.

In this example, the data storage device 38 includes ticket data 40 indicative of a single set of player characters or multiple sets of player characters selected by a player or selected randomly and corresponding to one or more games, ticket identification information, and participant information indicative of the participants which have been linked to the game(s) by the game controller 12; participant data 42 indicative of all participants in the event(s), including a team number allocated to each participant by the participant's team, the names of the participants, and the name of the team with which each participant is associated; performance data 44 indicative of the respective performances of the participants in the event(s) and which is received by the game controller 12 from the live performance data server 36 during the event(s), for example in the form of a points score; and game data 46 including data and programs used by the control unit 32 to determine operation of one or more games implemented by the gaming system 10 and data indicative of the game characters.

The game controller 12 also includes a random number generator 48 arranged to generate random numbers in response to the control unit 32, in one example for the purpose of randomly selecting player numbers 50 from a set of game numbers and, in this example, for randomly selecting participants to be associated with a game and/or randomly assigning game numbers from the set of game numbers to the selected participants.

It will be understood that the random number generator 48 may be of a type arranged to generate truly random numbers or may be arranged to generate pseudo random numbers, for example based on a time dependent seed number.

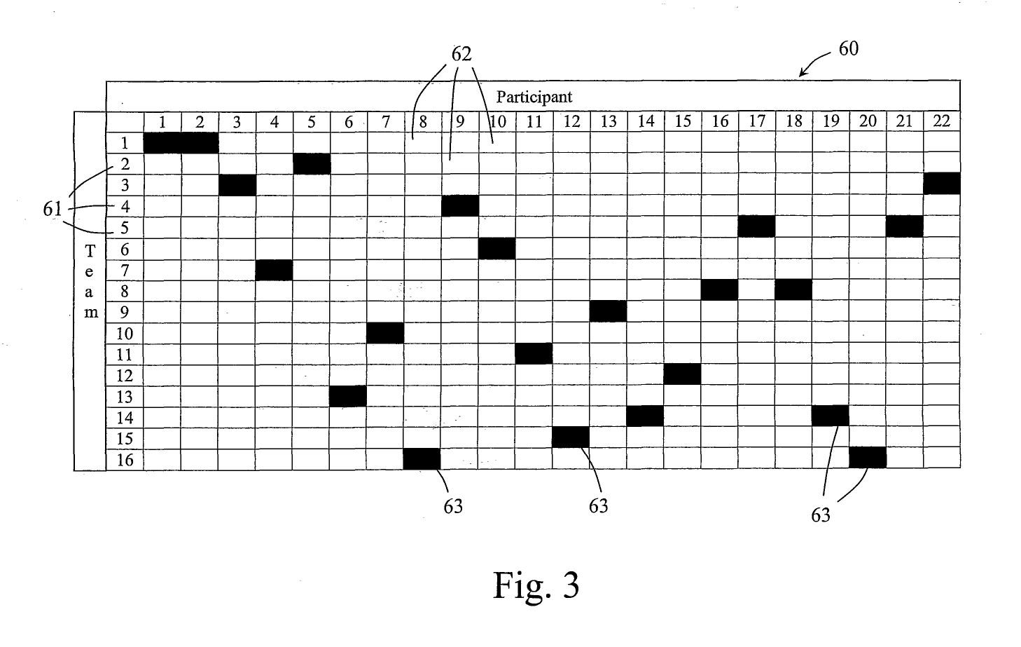

FIG. 3 shows a participant table 60 which details all participants which have been associated with a particular game. In this example, the participant table 60 corresponds to an Australian rules football competition which comprises 16 teams 61 with each team 61 fielding 22 participants 62 in a particular football game, 18 of which are directly involved in the football game at any time and 4 of which act as substitutes.

In one embodiment, when a person purchases a ticket, each game on the ticket includes a predefined number of player characters, in this example player numbers, which are selected either by the player or randomly by the game controller 12 from a set of game numbers, and participants are selected to be associated with the game. In this example 22 participants 63 are selected from a pool of 352 participants for association with the game.

It will be understood from FIG. 3 that in this example the participants are selected such that at least one participant is selected from each team 61 in the competition and such that one participant is selected from each playing position. In this way, each game has a team associated with it which comprises football players from all football teams and each possible football position is represented by a selected participant. For example, participant 1 may correspond to a left back pocket position, participant 2 may correspond to a centre back position, and so on. However, it will be understood that other arrangements are envisaged, such as selecting a set of participants randomly from all available participants.

The participants may also be selected with regard to the respective abilities of the participants so that a selected set of participants for association with a game is not significantly any more or less likely to produce a winning outcome than any other set of participants. This may be achieved by allocating a value to each participant which is representative of the ability of the participant, adding the respective values of all selected participants together and comparing the added values with a threshold value. If the added values exceed the threshold value, the system may be arranged to reselect a new set of participants.

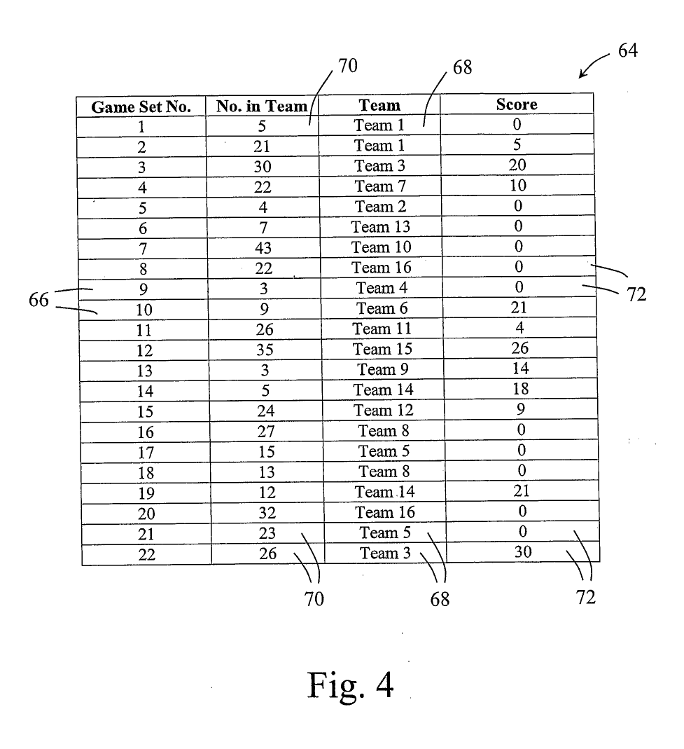

After selection of the set of participants 63 to be associated with a game, the selected set 63 of participants is stored in the data storage device 38, in this example as ticket data represented in this example by a selected participants table 64 shown in FIG. 4. The selected participants table 64 includes a game number 66 assigned to each participant in the selected set, a team number 70 which corresponds to the number allocated to the player in the player's team, the name of the participants team 68, and a score 72 which represents the total number of points allocated to the participants in the set on the basis of performance of each of the participants in an event.

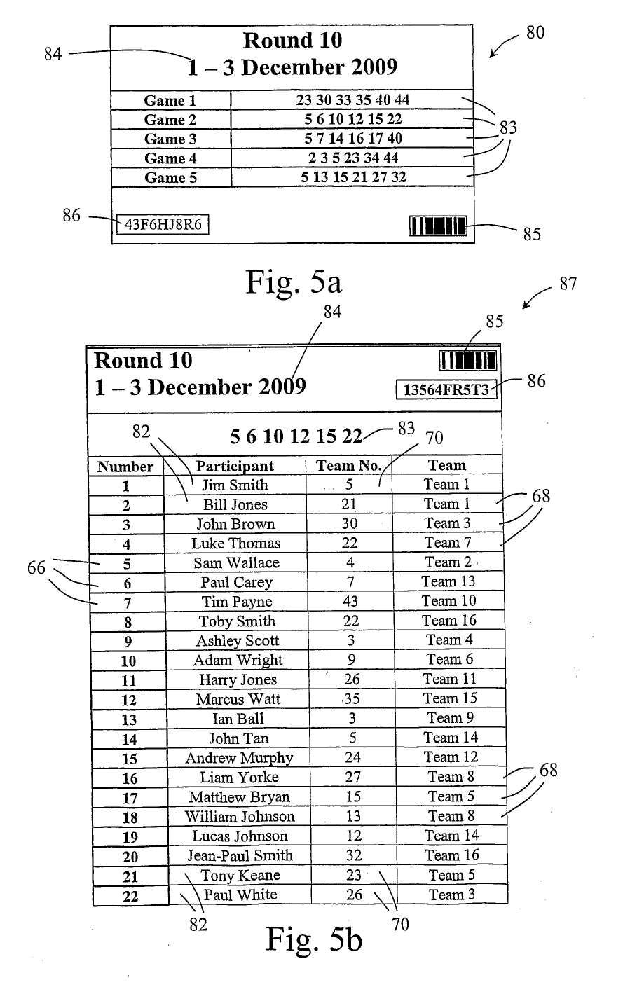

Referring to FIG. 5a, an example ticket 80 is shown which includes event indicia 84 indicative of the one or more events with which the ticket 80 is associated, and 5 sets of selected player numbers 83 corresponding to 5 purchased games. The ticket 80 also includes ticket identification indicia 85, in this example in the form of a barcode, for electronically identifying the ticket. The ticket 80 also includes an alphanumeric identifier 86, in this example an identification number, which is usable to identify the ticket and thereby the player numbers 83 associated with the ticket 80, for example so that progress of the game(s) can be monitored on-line.

In this example, the alphanumeric identifier 86 is a string of 10 characters which is unique for a ticket and randomly selected. The identifier 86 is linked to the ticket data 40 associated with the ticket and stored on the data storage device 38. It will be appreciated that since the identifier 86 comprises 10 randomly selected characters, it is difficult for anyone other than the holder of the ticket to gain access to the system so as to monitor progress of the game without knowledge of the identifier 86.

An alternative example ticket 87 is shown in FIG. 5b. The ticket 87 includes one set of selected player numbers 83 corresponding to one game, the names 82 of the participants' which have been associated with the game by the control unit 32, game numbers 66 which have been assigned to the participants, the team numbers 70, and the names of the participants' teams 68.

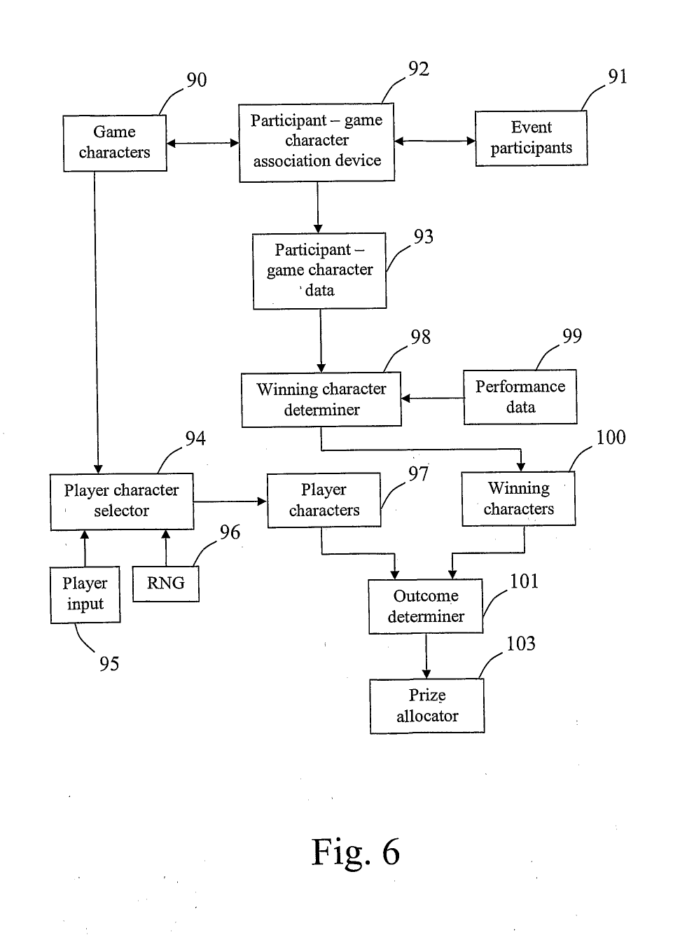

An example of functional components of the game controller 12 is shown more particularly in FIG. 6. In this example, the components are implemented using a suitable processor arranged to implement suitable programs, and associated memory for storing programs used by the processor and data used by and produced by the processor, although it will be understood that other implementations are envisaged.

The components comprise game characters 90, in this example forming part of the game data 46 stored in the data storage device 38 shown in FIG. 2, event participants 91, in this example forming part of the participant data 42 stored in the data storage device 38, and a participant-game character association device 92 arranged to link each game character with at least one event participant so as to produce participant-game character data 93.

The components also comprise a player character selector 94 arranged to allow a player to select characters from the game characters 90 to form the set of player characters 97, and/or arranged to automatically select characters from the game characters 90 to form the set of player characters, for example using a random number generator 96.

The components also include a winning character determiner 98 arranged to receive performance data 99 indicative of the performance of the participants in at least one event, and to use the performance data 99 and the participant-game character data 93 to determine which of the participants are the best performing, with the game characters corresponding to the best performing participants constituting the winning characters 100.

An outcome determiner 101 makes a comparison between the player characters 97 and the winning characters 100 and determines whether a winning condition exists. A prize allocator 103 allocates a prize appropriate for the winning condition should such a winning condition be determined to exist by the outcome determiner 101.

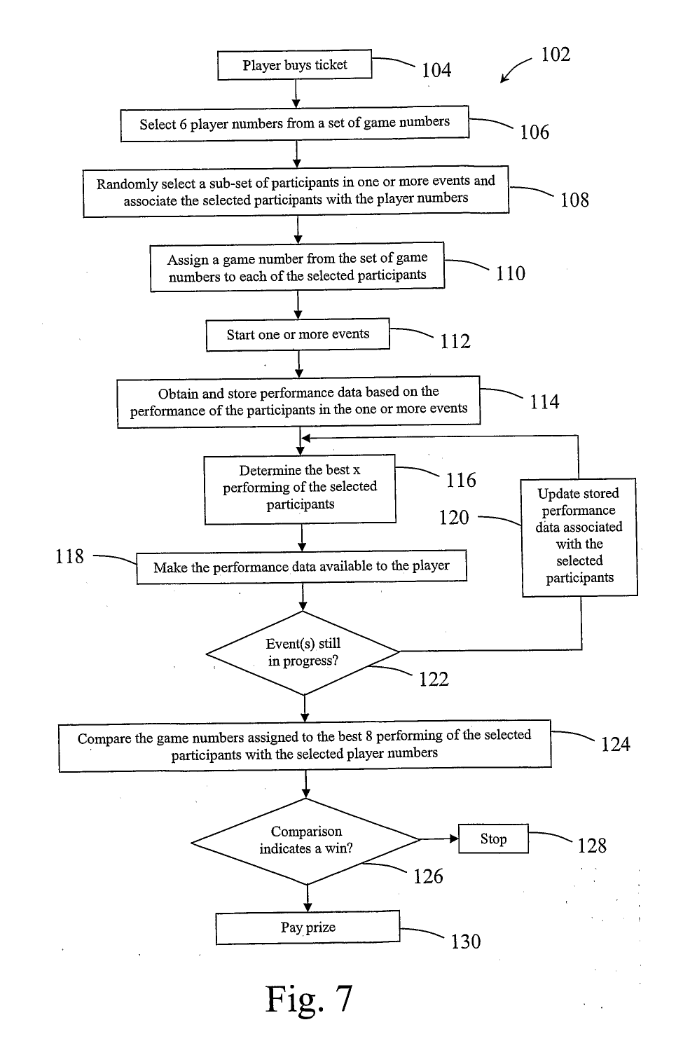

An example of operation of the present system and method will now be described with reference to FIGS. 7 to 10.

FIG. 7 shows a flow diagram 102 including steps 104 to 130 illustrating a specific detailed example of a method of gaming according to an embodiment of the present invention.

During use, a player first purchases a ticket 104 in any suitable way, for example using a dedicated terminal 16 by visiting an outlet equipped to sell tickets, by connecting to the game controller 12 through the Internet 26 using a personal computer 14, or by connecting to the game controller 12 through a telephone communications network and/or the Internet 26 using a personal digital assistant (PDA) or mobile telephone 20, 22. Payment for the ticket may be made in any suitable way, for example by providing credit card details using a personal computer 14, the dedicated terminal 16 or the PDA/mobile phone 20, 22 to the game controller 12 and thereby to a banking institution 29, or by providing cash directly to an operator of a dedicated terminal 16. The system may also be arranged so that user accounts may be provided, for example to users registered with the system, wherein a holder of a user account may pay for tickets using the user account.

After purchasing a ticket, for each game purchased, a set of 6 player numbers is selected 106 by the player or randomly from a set of game numbers using the character selector 94, and the game controller 12 selects and associates 108 a set of participants with each game. The game controller 12 also assigns 110, for example randomly, each game number from the set of game numbers to one of the selected participants.

In this example, the game numbers are associated with the equivalent of two Australian rules football teams each comprising 18 players plus 4 interchange players. Accordingly, the set of game numbers comprises 44 numbers between 1 and 44, and 44 participants are selected for association with the game, with each participant being assigned a game number between 1 and 44.

In the present example, the 44 participants are selected randomly using the random number generator 48, with the selected participants comprising two participants from each position in an Australian rules football team and at least two participants from each team in an Australian rules football competition. However, it will be understood that other arrangements are envisaged. For example, 22 participants corresponding to 1 Australian rules football team may be selected, and/or the participants selected without regard to the positions of the participants in an Australian rules football team and/or without regard to particular Australian rules football teams.

A physical ticket 80 may then be printed, for example using the printer 18 associated with the dedicated terminal 16, or using any printer (not shown) linked to a personal computer 14 associated with the player. If a ticket is purchased using a portable mobile communications device such as a PDA or mobile phone 20, 22, data indicative of the ticket may be stored on the PDA/phone for subsequent printing when the PDA/phone is in networked communication with a printer or for display on the PDA/phone only.

It will be understood that as an alternative, a physical ticket may not be printed or stored on a PDA or mobile phone and, instead, the ticket may be stored in electronic form at the game controller 12 and made accessible on-line using any suitable network enabled device.

In embodiments wherein progress of the game, and in particular progress of matches between the player numbers and the winning numbers, is monitorable on-line during the events, the ticket may include a unique identifier 86 which identifies the ticket and thereby the player numbers, associated participants and game numbers assigned to the participants. The identifier may for example be entered into a website and used by the website to extract and display information indicative of progress of the game(s) associated with the ticket.

After commencement of at least one event 112, in this example multiple football games in a round of an Australian rules football competition, the performance data gathering device 34 receives 114 live performance data 30 from the live performance data server 36 indicative of the performance of all participants in the currently played Australian rules football games, and the performance data 30 is stored in the data storage device 38. The performance data 30 comprises a points score for each participant based on the performance of the participant in an Australian rules football game.

The performances of the participants associated with each game are then evaluated and the 8 highest scores of the selected participants associated with each game are identified 116. The game numbers associated with the 8 highest scoring participants are then stored in the data storage device as a current set of winning numbers.

The player numbers are then compared 124 with the winning numbers 50 and any numbers in the player numbers which match with numbers in the winning numbers are marked.

As shown in the flow diagram 102, the game controller 12 periodically updates 120 the performance data and using the performance data updates the scores of the participants.

As indicated at step 118, for each ticket the performance data of participants associated with the game(s) are made available to the holder of the ticket between commencement of the event(s) and finalisation of the event(s) and, in particular, information is made available indicative of whether any matches between the player numbers and the winning numbers exist. It will be appreciated that since the 8 participants with the highest scores are used to determine the winning numbers, as the events progress the 8 best performing participants may change and as a consequence the winning numbers and therefore the winning status of a set of player numbers is in a state of flux until the final event has been completed.

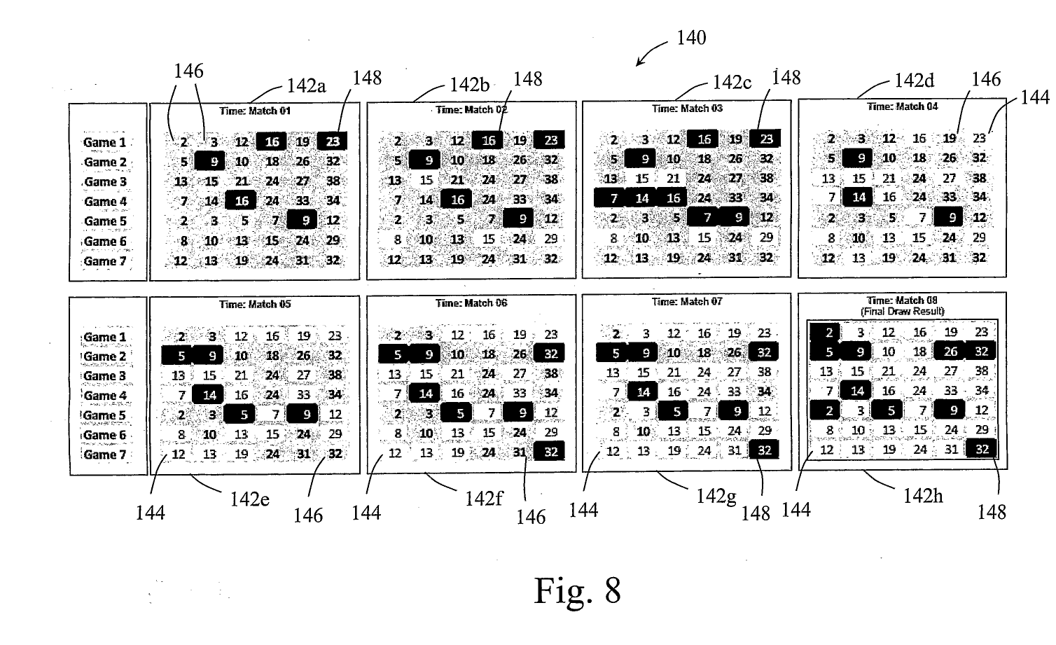

An example game status screen 140 which is accessible by a player to view the current status of a ticket is shown in FIG. 8. The game status screen 140 includes a game status card 142 which indicates the progress of the game and each of the game cards 142 shown in FIG. 8 shows the game status at a different time over a round of 8 games. Accordingly, it will be understood that although 8 game cards 142 are shown in FIG. 8, only one game status card would be shown at any given time. The game status screen 140 may be accessed on-line in any suitable way, for example through the Internet 26 using any suitable network communications enabled device, such as a personal computer 14, PDA or mobile phone 20, 22, and by providing the identifier 86 provided on the ticket 80, 87.

In the present example, the events are games in a round of an Australian rules football competition, the player associated with the ticket has purchased 7 games and each game has a respective set of player numbers.

For ease of reference, the player numbers are displayed differently to indicate whether the event with which a participant is associated has finished and the player number is no longer able to match a winning number because at least 8 other game numbers have associated higher participant performance scores, in this example by displaying the number with a white background; whether the event with which a participant is associated has not yet commenced or is in progress and the player number does not currently correspond to a win, in this example by displaying the number with a grey background; and to indicate whether a player number matches one of the winning numbers, in this example by displaying the number with a black background. The game status screen 140 may also be arranged to indicate to a player when the event with which a participant is associated is still in progress, for example by flashing the numbers associated with events in progress, and/or to indicate to a player whether a player number is matched with a main winning number or a supplementary winning number.

It will be appreciated that the game status screen 140 provides a player with the ability to track the progress of one or more games as one or more events progress, and in this way the player is provided with a degree of enjoyment. For example, after three football game events, game 4 has 3 matching numbers shown on the game card 142c, which will have the effect of providing the player with a degree of anticipation that a winning outcome may occur. However, after 8 football game events only 1 matching number exists, as shown on the game card 142h.

If at the end of all events a defined number of matches are present, for example 4 of the player numbers or all 6 of the player numbers match with the winning numbers, the player wins a prize.

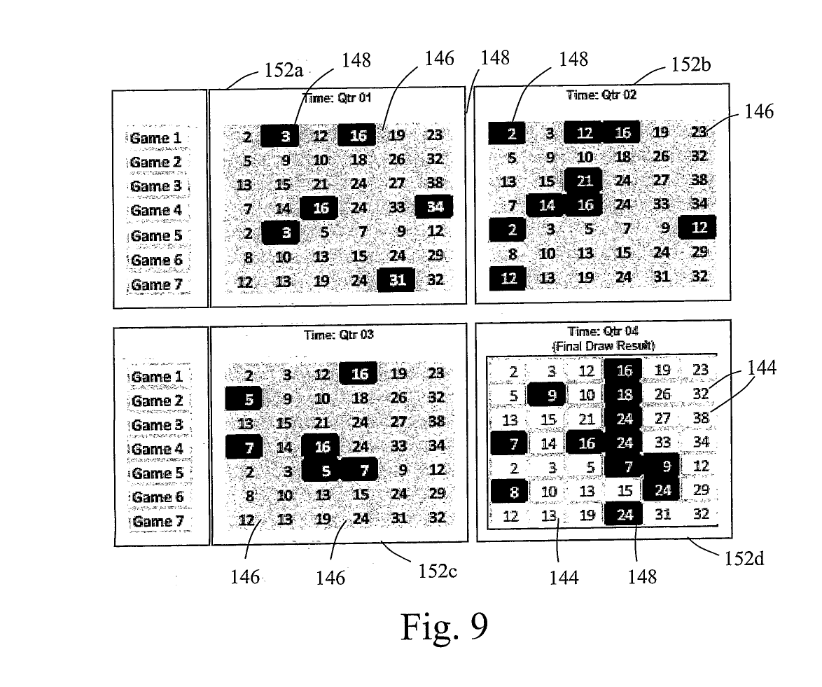

Game cards 152 for an alternative game are shown in FIG. 9. In this example, the game is associated with one event having a plurality of game sections, such as one game of Australian rules football which comprises four quarters. As with FIG. 8, the game cards 152a, 152b, 152c, 152d shown in FIG. 9 represent one game card 152 at different stages in the game, in this example after each quarter of the game. It will be appreciated that since this game is based only on one Australian rules football game, the status of the player numbers on the game card 152 will change relatively quickly.

In one arrangement, access to the game controller may be facilitated by providing an application for a mobile phone or PDA.

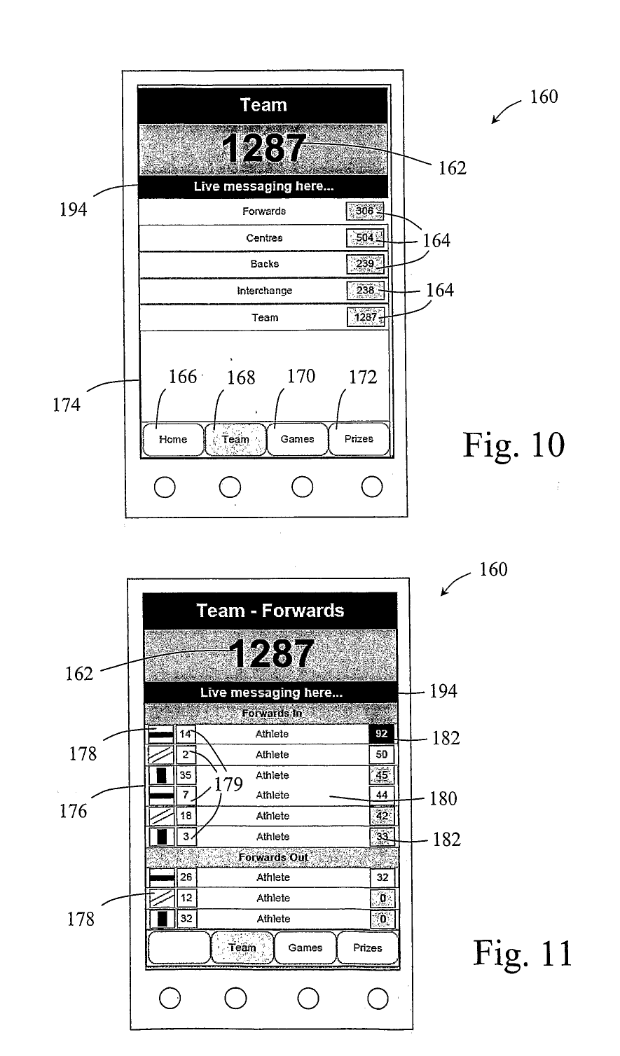

Referring to FIGS. 10 to 15, a representation of a touch phone 160 is shown, the touch phone including on a home page 174 a total points score 162 which corresponds to the sum of all points scored by all participants associated with the particular game or scored by some of the participants, which may be randomly selected, summary information 164 as to the total number of points scored by forwards, centres, backs and interchange of selected participants corresponding to an Australian rules football team, and navigation buttons 166, 168, 170, 172 usable by a player to navigate to a respective home page 174, team pages 176, 190, a games page 192 and a prizes page (not shown).

In this example, in addition to prizes awarded on the basis of matches between player numbers and winning numbers, other prizes may also be awarded, such as on the basis of the total points 162 scored by all participants, by a defined number of the best performing participants, or by a randomly selected set of the participants.

It will be understood that in an example wherein the game is based on one event, for example an Australian Rules football game comprising 44 participants, with 44 game numbers randomly assigned to the participants, for the purpose of determining the total points score, a subset of the 44 participants may be randomly selected for each game or for multiple games associated with the same ticket. This ensures that different total points scores are produced for multiple players.

The mobile phone application may also include a live messaging feed display area 194 usable to display any relevant game information to a player and/or advertising information.

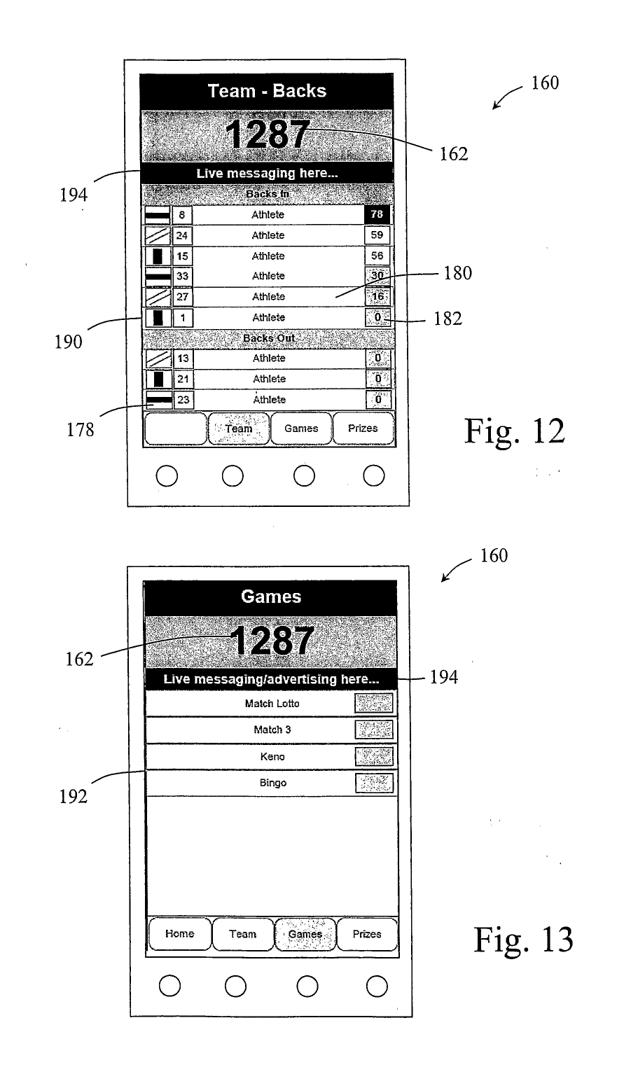

A representation of a team forwards page 176 is shown in FIG. 12. The team forwards page 176 includes for each forward participant a team icon 178 indicative of the team with which the participant is associated, a game number 179, a participant name 180, and the points score 182 associated with the participant. In a similar way to the way that player numbers are represented differently on the game status screens 140, 150 shown in FIGS. 9 and 10, as an alternative the points scores 182 may be represented differently depending on whether the relevant participant has finished playing and is no longer able to give rise to a match with a player number, has yet to play, is currently playing and/or whether a participant corresponds to a match with a player number.

The participants listed under heading ‘forwards in’ correspond to the forward participants with the highest 6 performance scores. The forward participants listed under heading ‘forwards out’ correspond to the forward participants which are outside the highest 6 performance scores for forwards.

Similarly, the team backs page 190 includes for each back participant a team icon 178 indicative of the team with which the participant is associated, a participant number 179, a participant name 180, and the points score 182 associated with the participant.

The participants listed under heading ‘backs in’ correspond to the back participants with the highest 6 performance scores. The back participants listed under heading ‘backs out’ correspond to the back participants which are outside the highest 6 performance scores for backs.

The participants listed under the forwards in and backs in headings in this example correspond to the participants which will contribute to the total points score. The participants listed under the forwards out and backs out headings in this example correspond to the participants which do not contribute to the total points score.

The system may be arranged such that in the event that 2 or more players achieve the same number of matches between player numbers and winning numbers, an equal prize is awarded to the players, the prize appropriate for the number of matches is equally divided between the winning players, or an additional criterion is applied to the players to determine which of the players will win the prize. For example, the total points score discussed above may be used to make the determination, such as based on which of the players has the highest associated total points score.

A games page 192 is shown in FIG. 13. Using the games page 192, a player is able to navigate to game specific pages relevant to various games which may be played by a player, at least some of which embody the present invention.

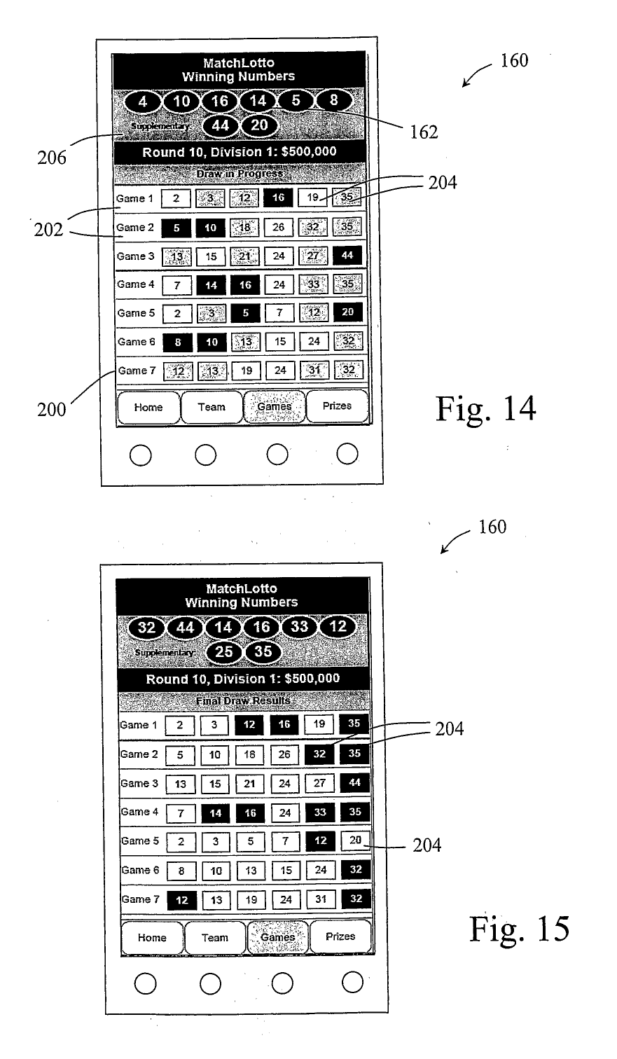

As shown in FIG. 14, a game progress page 200 relevant to a game based one or more Australian rules football games is shown. The game progress page 200 includes information relevant to a plurality of games 202 which have been purchased by a player, in this example 7 games, and identifying 6 player numbers 204 selected for each of the games. The game progress page 200 also includes the current winning numbers 206 which are derived based on the performance of the participants associated with the games. As with FIGS. 12 and 13, a player number may be represented differently depending on whether the relevant participant has finished playing, has yet to play, is currently playing and/or whether a player number matches with a winning number.

A similar game progress page is shown in FIG. 15, but representing the final game situation, that is, after the winning numbers have been finalised and thereby which shows how many matches exist between the player numbers and the winning numbers at the end of the game.

While the above embodiments are described in relation to events in the form of Australian rules football games, it will be understood that other events are envisaged such as other sporting events including soccer, cricket, baseball, American rules football events, racing events such as horse or greyhound racing or motor racing, any other sporting event, or a combination of several sporting events. The invention may also be applied to other non-events such as performance of a defined set of companies on the stock exchange, or any other event wherein the performance of several individuals or entities may be objectively measured and the performance ranked and used to determine a set of winning numbers. For example, the invention may be applied to performance of particular songs in relation to number of plays on one or more radio stations, and so on.

It will be appreciated that the at least one event on which the eventual winning numbers are based may comprise any number of events and may be of very short duration such as one horse race or may be of medium or long term duration, such as over a weekend, a week, or a year. For example, the events may comprise all games in a particular team sport season. Also, an ‘event’ for the purpose of the present gaming system may constitute part of a greater event such as part of an Australian rules football game, for example 10 minutes of the football game.

It will also be appreciated that although the above examples are described in relation to a lottery, the invention may equally be applied to other type of draw based game, such as keno, bingo or numbers games.

It will also be understood that while the above embodiments are described in relation to a gaming system wherein a sub-set of participants is selected from a pool of participants and used to determine the winning numbers, other arrangements within the scope of the present invention are envisaged. For example, all participants in at least one event may be randomly assigned a game number and used to determine the winning numbers.

It will also be understood that one or more sets of player numbers may be associated with the same set of participants and the participants in the sets of participants linked to different numbers of a set of game numbers so that different winning numbers are defined at the end of a game.

In an embodiment wherein multiple games and thereby multiple sets of player numbers are included on the same ticket, each set of player numbers may be associated with a different set of participants such that the winning numbers are different for each set of player numbers, or all sets of player numbers may be associated with the same set of participants such that the winning numbers are the same for each set of player numbers.

Furthermore, it will be understood that instead of providing different sets of player numbers for multiple games associated with the same event(s), one set of player numbers may be selected for all games associated with the same event(s), and participants randomly assigned to each game and/or participant numbers randomly assigned to selected participants.

The important aspect is that in a game the winning numbers used to compare with a set of selected player numbers are determined based on the performance of the participants assigned to the game characters.

In this way, it will be appreciated that unlike conventional lottery gaming systems, the winning numbers can change between purchasing a ticket and conclusion of the game, since the relevant winning numbers to use in the comparison with the player numbers are dependent on external events.

While the present embodiment comprises a set of game characters in the form of game numbers, it will be understood that the characters may be of other types, such as symbols, playing card indicia, and so on.

It will also be understood that the game characters may be event participant names or graphical indicia indicative of event participants instead of numbers. With this arrangement, participant names or graphical indicia indicative of participants which have been selected by a player or selected randomly by the gaming system would be shown on the ticket purchased by the player as player characters. As with the previous embodiments, the player characters would then be compared with a set of winning characters to determine the game outcome, the winning characters in this embodiment being the participant names or graphical indicia indicative of the best performing participants during one or more events.

It will be appreciated that for an embodiment wherein the player characters correspond to participants selected by a player, for example wherein the player characters are participant names, the gaming system may be arranged so as to normalise the likelihood of a particular set of participant names constituting a winning outcome so that no particular combination of participant names selected by a player as the player characters is significantly more likely to constitute a winning outcome than other combinations.

For example, each participant may be provided with a handicap value used to modify the participant performance score according to the determined ability of the participant.

As an alternative, each participant may be allocated a point value and the players allowed to select the participants to form the player characters up to a combined maximum total points value. Similarly, when the winning characters are determined according to the performance of the participants in one or more events, the participants used are determined also according to the maximum total points value, for example by using the highest performance points ranking participant combination which satisfies the maximum total points value criterion.

With an embodiment wherein the player characters are event participant names or graphical indicia indicative of event participants, the gaming system may be arranged to allow a player to change at least some of the player characters, for example because the player perceives that one or more participants are less likely to perform as well as other participants and therefore are less likely to correspond to winning characters than other participants. In one such variation, a player is allowed to change up to one less than the total number of player characters. It will be understood that this variation may provide a player with a poker game type experience.

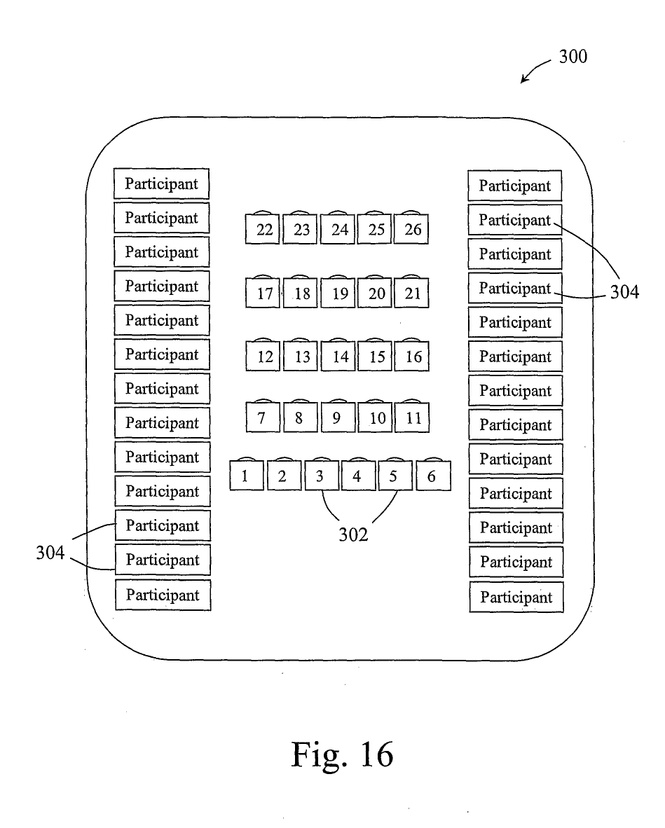

A further variation is shown in FIG. 16 which illustrates a player character selection screen 300 which is displayed to a player during a player character selection process of a game. The player character selection screen in this example includes a plurality of cases 302, each of which has an associated number and each of which has an event participant associated with it. Selection by a player of a case 302 causes a participant name associated with the case number to appear in one of the participant boxes 304.

It will be appreciated that other graphical arrangements may be provided to present a game or part of a game, including selection by a player of player characters, to a player in order to enhance the visual and interactive appeal of the game to a player.

Modifications and variations as would be apparent to a skilled addressee are deemed to be within the scope of the present invention.

1.-83. (canceled)

84. A gaming system comprising:
a selector arranged to facilitate selection of a player set of characters from a set of game characters;
the gaming system being arranged to associate participants in at least one event with respective game characters of the set of game characters;
a winning character determiner arranged to determine a set of winning characters from the game characters associated with the participants based on performance of the participants in the at least one event; and
an outcome determiner arranged to determine whether a win condition exists by comparing the player characters with the winning characters;
wherein the gaming system is arranged such that the likelihood of each player obtaining a win condition is substantially the same.

85. A gaming system as claimed in claim 84, wherein for each game the player characters are the same for all players, and the gaming system is arranged such that for each player the participants are randomly associated with respective game characters of the set of game characters.

86. A gaming system as claimed in claim 84, wherein the gaming system is arranged to select a sub-set of a set of participants in at least one event, and to associate each participant of the selected sub-set of participants with a game character.

87. A gaming system as claimed in claim 86, wherein the sub-set of participants is randomly selected from the set of participants.

88. A gaming system as claimed in claim 84, wherein the game characters are randomly associated with respective participants.

89. A gaming system as claimed in claim 84, wherein:
the winning character determiner is arranged to determine the set of winning characters by determining a defined number of game characters corresponding to the best performances of the participants associated with the game characters in the at least one event; the system is arranged to receive a points score indicative of the performance of each participant and the winning character determiner is arranged to determine the best performing participants by ranking the points scores;
the gaming system is arranged to combine the points scored by a plurality of participants, and the outcome evaluator is arranged to determine a winning outcome dependent on the combined points score; and
the participants used to produce the combined points score are all participants associated with the game characters, or a sub set of participants associated with the player characters.

90. A gaming system as claimed in claim 89, wherein the outcome evaluator is arranged to define a first win condition if the player characters match with a first set of winning characters, and to define a second win condition if the player characters match with a second set of winning characters, the second set of winning characters having more winning characters than the first set of winning characters and the first and second win conditions corresponding to different prizes.

91. A gaming system as claimed in claim 84, wherein the game characters, the player characters and the winning characters are participant names or graphical indicia representative of participants and, wherein the gaming system is arranged so as to normalise the likelihood of a particular set of participant names constituting a winning outcome so that no particular combination of participant names selected by a player as the player characters is significantly more likely to constitute a winning outcome than other combinations.

92. A gaming system as claimed in claim 91, wherein the gaming system is arranged to allocate a handicap value to each participant and to use the handicap value to modify the participant performance score according to the ability of the participant.

93. A gaming system as claimed in claim 91, wherein the gaming system is arranged to allocate a point value to each participant indicative of the ability of the participant, and to allow a player to select the participants to form the player characters up to a combined maximum total points value, and wherein the winning character determiner is arranged to determine winning characters by using the highest performance points ranking participant combination which is within the maximum total points value.

94. A gaming system as claimed in claim 84, wherein the gaming system is arranged to continually update the set of winning characters during the at least one event such that a current set of winning characters is based on current performance of the participants in the at least one event.

95. A method of gaming comprising:
associating participants in at least one event with respective game characters of a set of game characters using a character association device;
selecting a player set of characters from the set of game characters;
determining a set of winning characters from the game characters associated with the participants using a winning character determiner, the winning characters being determined based on performance of the participants in the at least one event;
determining whether a win condition exists by comparing the player characters with the winning characters using an outcome determiner; and
ensuring that the likelihood of each player obtaining a win condition is substantially the same.

96. A method as claimed in claim 95, comprising facilitating selection of player characters from the set of game characters by a player.

97. A method as claimed in claim 95, comprising facilitating selection of the player characters automatically.

98. A method as claimed in claim 97, comprising randomly selecting the player characters from the set of game characters.

99. A method as claimed in claim 95, wherein the method comprises:
selecting a sub-set of a set of participants in at least one event; and
associating each participant of the selected sub-set of participants with a game character.

100. A method as claimed in claim 99, comprising randomly selecting the sub-set of participants from the set of participants.

101. A method of determining winning characters in a game wherein an outcome of the game is dependent on selection of the winning characters, the method comprising:
associating participants in at least one event with respective characters of a set of game characters; and
determining a winning set of characters from said game characters based on performance of said participants in the at least one event, and,
normalising the winning characters such that no particular combination of winning characters is significantly more likely to constitute a winning outcome than other combinations by allocating a handicap value to one or more of the participants.

102. A method as claimed claim 101, comprising allocating to each participant performance points for carrying out an action during an event, and allocating a different amount of performance points for at least some of the actions.

103. A method as claimed in claim 101, comprising for each game associating the game characters with different participants for at least some players.
